(19) United States
(12) Patent Application Publication
(10) Pub. No.: US 2009/0162661 A1
(43) Pub. Date: Jun. 25, 2009

(54) MULTI-LAYERED MOLDED ARTICLE WITH TACTILITY

(75) Inventors: KUN-TSAN WU, Shindian (TW); LI-WEN TIEN, Shindian (TW)

Correspondence Address: PCE INDUSTRY, INC.;ATT. Steven Reiss, 458 E. LAMBERT ROAD, FULLERTON, CA, 92835, US

(73) Assignee: FIH (HONG KONG) LIMITED, Kowloon (HK)

(21) Appl. No.: 12/168,228

(22) Filed: Jul. 7, 2008

(30) Foreign Application Priority Data
Dec. 20, 2007 (CN) 200710203284.4

(51) Int. Cl. B32B 9/00

(52) U.S. Cl. 428/411.1

(57) ABSTRACT

A multi-layered molded article (10) for being provided with tactility is provided. The multi-layered molded article includes a substrate (14), a soft layer (12) directly formed on the substrate, and a dustproof layer (11) directly formed on the soft layer. The soft layer is positioned between the substrate and the dustproof layer.

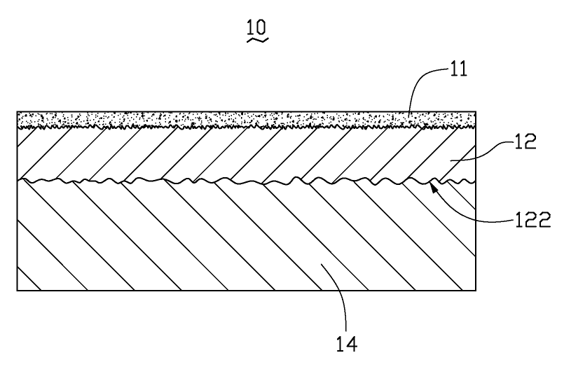

### CROSS-REFERENCE TO RELATED APPLICATIONS

This application is one of the ten related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket | | |
| No. | Title | Inventors |
| US18024 | MULTI-LAYERED MOLDED ARTICLE | Kun-Tsan Wu |
| | WITH DECORATIVE LAYER AND | et al. |
| | METHOD | |
| US18396 | MULTI-LAYERED MOLDED ARTICLE | Kun-Tsan Wu |
| | WITH IMPROVED BONDING BETWEEN | et al. |
| | LAYERS | |
| US18397 | MULTI-LAYERED MOLDED ARTICLE | Kun-Tsan Wu |
| | WITH MOISTURE PROTECTION | et al. |
| US18398 | MULTI-LAYERED MOLDED ARTICLE | Kun-Tsan Wu |
| | WITH MOISTURE PROTECTION | et al. |
| US18399 | WATERPROOF MULTI-LAYERED | Kun-Tsan Wu |
| | MOLDED ARTICLE | et al. |
| US18400 | MULTI-LAYERED MOLDED ARTICLE | Kun-Tsan Wu |
| | WITH TACTILITY | et al. |
| US18401 | MULTI-LAYERED MOLDED ARTICLE | Kun-Tsan Wu |
| | WITH EMI PROTECTION | et al. |
| US18402 | METHOD FOR MAKING | Kun-Tsan Wu |
| | MULTI-LAYERED MOLDED ARTICLES | et al. |
| US18403 | METHOD FOR MAKING | Kun-Tsan Wu |
| | MULTI-LAYERED MOLDED ARTICLES | et al. |
| US18404 | METHOD FOR MAKING | Kun-Tsan Wu |
| | MULTI-LAYERED MOLDED ARTICLES | et al. |

### BACKGROUND

1. Field of the Invention

The present invention relates to multi-layer molded articles.

2. Description of Related Art

Molded articles, such as molded shells, are widely used in many technological fields. One example is a molded shell used with a portable electronic device (e.g., a mobile phone) for protecting internal electronic components. Another example is a molded shell used with furniture (e.g., a mini sofa) to provide decoration.

The molded shells may include a plastic substrate having some kind of decorative and/or protective (hereinafter “second”) layer formed thereon. The molded shell may be made using an insert molding process. The second layer is placed in the mold cavity and then bonds to the molten plastic injected into the mold for forming the substrate.

Various difficulties may be faced when manufacturing this multi-layer molded article.

Therefore, there is room for improvement within the art.

### BRIEF DESCRIPTION OF THE DRAWINGS

Many aspects of the present multi-layered molded article with tactility can be better understood with reference to the following drawing. The drawing is not necessarily drawn to scale, the emphasis instead being placed upon clearly illustrating the principles of the present multi-layered molded article. Moreover, in the drawing like reference numerals designate corresponding parts throughout the view. Wherever possible, the same reference numbers are used throughout the drawing to refer to the same or like elements of an embodiment.

The drawing is a cross-sectional view of a multi-layered molded article with a textured surface according to an exemplary embodiment.

### DETAILED DESCRIPTION OF THE EXEMPLARY EMBODIMENTS

Referring to the drawing, a multi-layered molded article 10 is shown. Article 10 includes a substrate 14 having a soft layer 12 and a dustproof layer 11 formed thereon. The soft layer 12 is disposed between the substrate 14 and the dustproof layer 11.

The dustproof layer 11 may be made of a nanophase material. Alternatively, the dustproof layer 11 can be a dustproof coating coated on the soft layer 12. The nanophase material can be one of: a fluorinated organo-silicon nanophase material, a silicon nitride nanophase material, and an aluminium nitride nanophase material. The dustproof coating can also be made of materials selected from an ethoxyline resin dustproof coating and a polyurethane dustproof coating.

The soft layer 1212 may be made of a material that is soft relative to the substrate 14. Exemplary soft materials include leather (natural and artificial), all types of fabrics, woven clothes, textiles, and nylon. One surface of the soft layer 12 acts as a bonding surface 122. The bonding surface 122 should have a rough or coarse surface, formed by, for example, a plurality of tiny pores or projections (schematically shown). For some soft materials, the pores and projections of the bonding surface 122 may be a natural property of the material. For other soft materials, the pores and projections may be formed by grinding or sandblasting the bonding surface 122. The tiny pores and projections of the bonding surface 122 interlock with the molten material used to make substrate 14, thereby increasing the bonding of the soft layer 12 to the substrate 14.

The substrate 14 can be molded by injection molding. The substrate 14 can be formed by injection molding a moldable material. The moldable material can be any of plastic, rubber, and silicon. The plastic material can be any of polyvinylchloride resin (PVC), polyethylene terephthalate (PET), acrylonitrile-butadiene-styrene (ABS), polycarbonate (PC), polyimide (PI), liquid crystal polymer (LCP), polyetherimide (PEI), polyphenylene sulfide (PPS), polystyrene (PS), polypropylene (PP). In particular, ABS and PCexhibit good adhesion to many softer materials.

When manufacturing the multi-layered molded article 10, the substrate 14 is insert molded with the soft layer 12 using typical insert molding decorating (IMD) technology. The exterior surface of the soft layer 12 is roughened by grinding or sandblasting. The dustproof layer 11 is thin and directly formed on the roughened exterior surface of the soft layer 12 using spray painting.

This process results in the soft layer 12 not being easily detached from the substrate 14. Also, the dustproof layer 11 can maintain a long-lasting and clean appearance of the multi-layered molded article 10. Finally, the soft and tactile features of the soft layer can be felt through the thin dustproof layer.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-layered molded article, comprising:
a substrate;
a soft layer directly formed on the substrate, the soft layer including a rough bonding surface, the rough bonding surface bonded to an exterior surface of the substrate; and
a dustproof layer directly formed on the soft layer, the soft layer positioned between the substrate and the dustproof layer.

2. The multi-layered molded article as claimed in claim 1, wherein the soft layer is made of a material selected from the group consisting of: leather and fabric.

3. The multi-layered molded article as claimed in claim 2, wherein the soft layer is made of a material selected from the group consisting of: natural leather, man-made leather, cotton fabric, wool fabric, plastic fabric, and nylon.

4. The multi-layered molded article as claimed in claim 3, wherein the bonding surface is rough because the soft layer is made of cotton fabric.

5. The multi-layered molded article as claimed in claim 3, wherein the bonding surface is surface treated to be rough.

6. The multi-layered molded article as claimed in claim 1, wherein the bonding surface has a plurality of tiny pores or projections.

7. The multi-layered molded article as claimed in claim 1, wherein the substrate is made from a material selected from the group consisting of: plastic, rubber, and silicon.

8. The multi-layered molded article as claimed in claim 1, wherein the dustproof layer is made of a nanophase material.

9. The multi-layered molded article as claimed in claim 8, wherein the nanophase material is made from a material selected from the group consisting of: a fluorinated organosilicon nanophase material, a silicon nitride nanophase material, and an aluminium nitride nanophase material.

10. The multi-layered molded article as claimed in claim 1, wherein the dustproof layer is a dustproof coating coated on the soft layer.

11. The multi-layered molded article as claimed in claim 10, wherein the dustproof coating is one of ethoxyline resin or polyurethane.
